(19) United States
(12) Patent Application Publication
(10) Pub. No.: US 2017/0154595 A1
(43) Pub. Date: Jun. 1, 2017

(54) DISPLAY DEVICE

(71) Applicant: SAMSUNG DISPLAY CO., LTD., Yongin-City (KR)

(72) Inventor: Moon Shik KANG, Yongin-si (KR)

(21) Appl. No.: 15/178,642

(22) Filed: Jun. 10, 2016

(30) Foreign Application Priority Data
Nov. 27, 2015 (KR) 10-2015-0167208

(51) Int. Cl. G09G 3/36

(52) U.S. Cl. CPC G09G 3/3677; G09G 3/3688; G09G 2300/0426; G09G 2320/0673; G09G 2300/0809; G09G 2310/0286; G09G 2310/0289; G09G 2310/08

(57) ABSTRACT

A display device includes a display panel including a pixel array, in which pixels connected to data lines and scan lines are disposed in a matrix form, a timing controller which controls driving of the display panel, a power supply unit which supplies power, a printed circuit board, a flexible circuit board which includes one end connected to the display panel and the other end connected to the printed circuit board and electrically connects the display panel and the printed circuit board, a data driving unit which provides a data signal to the data lines, a shift register which sequentially provides a scan signal to the scan lines, and a scan driver which is disposed at one side of the display panel, and provides level-shifted signals using a clock signal provided from the timing controller and power provided from the power supply unit to the shift register.

This application claims priority to Korean Patent Application No. 10-2015-0167208, filed on Nov. 27, 2015, and all the benefits accruing therefrom under 35 U.S.C. §119, the content of which in its entirety is herein incorporated by reference.

### BACKGROUND

1. Field

Exemplary embodiments of the invention relate to a display device.

2. Description of the Related Art

A display device generally includes a display panel, on which scan lines and data lines cross, a scan driver for driving the scan lines, a data driver for driving the data lines, and a timing controller for controlling driving timings of the scan driver and the data driver.

In an exemplary embodiment, scan drive integrated circuits (“ICs”) of the scan driver in the display device may be embedded in the display panel in a chip on glass (“COG”) method, and may be simultaneously embedded in the display panel together with a pixel array in a gate drive IC in panel (“GIP”) method, for example.

Printed circuit boards (“PCBs”) having different structures may be applied to each of the display device including the scan driver in the COG method and the display device including the scan driver in the GIP method by the display panels having different structures. It is desired to apply the PCBs having the different structures according to the mounting method of the scan driver, so that manufacturing cost of the PCB may increase.

### SUMMARY

Since printed circuit boards (“PCBs”) having different structures are applied according to a mounting method of a scan driver, a manufacturing cost of the PCB may increase.

In one embodiment, there are provided a display device, in which a PCB is applied regardless of a mounting method of a scan driver and of which manufacturing cost may be decreased.

An exemplary embodiment of the invention provides a display device, including a display panel including a pixel array, in which pixels connected to a plurality of data lines and a plurality of scan lines are disposed in a matrix form, a timing controller which controls driving of the display panel, a power supply unit which supplies power for driving the display panel, a PCB, in which the timing controller and the power supply unit are disposed, a flexible circuit board, which includes one end connected to the display panel and the other end connected to the PCB and electrically connects the display panel and the PCB, a data driving unit which is disposed in the flexible circuit board and which provides a data signal to the plurality of data lines, a shift register which is directly disposed on a substrate of the display panel and which sequentially provides a scan signal to the plurality of scan lines, and a scan driver which is disposed at one side of the display panel, and which provides level-shifted signals using a clock signal provided from the timing controller and power provided from the power supply unit to the shift register.

In an exemplary embodiment, the scan driver may include a level shifter disposed in the substrate of the display panel.

In an exemplary embodiment, the shift register may be disposed in a peripheral area of the pixel array.

In an exemplary embodiment, the scan driver may be disposed on the substrate of the display panel and spaced apart from the shift register.

In an exemplary embodiment, the PCB may include a first conductive wire, which electrically connects the flexible circuit board and the timing controller, and a second conductive wire, which electrically connects the flexible circuit board and the power supply unit.

In an exemplary embodiment, the shift register may include a plurality of transistors disposed on the substrate of the display panel together with the pixel array.

In an exemplary embodiment, the flexible circuit board may include a chip on film.

In an exemplary embodiment, the display device may further include a connection wire which is positioned at one side of the display panel and which electrically connect the flexible circuit board and the scan driver.

In an exemplary embodiment, the connection wire may include line-on-glass (“LOG”) wires directly disposed on the substrate of the display panel.

According to the exemplary embodiment of the invention, it is possible to minimize the number of components disposed in the PCB and decrease a size of the PCB by directly disposing the scan driver and the shift register on the same substrate of the display panel. Further, the size of the PCB is decreased, so that it is possible to decrease manufacturing cost of the PCB.

Further, it is possible to apply the PCB regardless of a mounting method of the scan driver by displaying the scan driver and the shift register on the same substrate of the display panel.

Further, the shift register directly receives the signals from the scan driver, so that it is possible to minimize signal distortion.

### BRIEF DESCRIPTION OF THE DRAWINGS

Exemplary embodiments will now be described more fully hereinafter with reference to the accompanying drawings, however, they may be embodied in different forms and should not be construed as limited to the embodiments set forth herein. Rather, these embodiments are provided so that this disclosure will be thorough and complete, and will fully convey the scope of the exemplary embodiments to those skilled in the art.

FIG. 1 is a block diagram illustrating an exemplary embodiment of a display device according to the invention.

FIG. 2 is a top plan view illustrating one pixel of FIG. 1.

FIG. 3 is a circuit diagram illustrating a shift register of FIG. 1.

FIG. 4 is a top plan view for describing a connection relation between the printed circuit board and a display panel.

FIG. 5 is an enlarged top plan view of a part Q1 of FIG. 4.

### DETAILED DESCRIPTION

Advantages and features of the invention and methods of achieving the advantages and features will be clear with reference to exemplary embodiments described in detail below together with the accompanying drawings.

However, the invention is not limited to the exemplary embodiments set forth below, and may be embodied in various other forms. The exemplary embodiments are for rendering the description of the invention complete and are set forth to provide a complete understanding of the scope of the invention to a person with ordinary skill in the technical field to which the invention pertains, and the invention will only be defined by the scope of the claims. Like reference numerals indicate like elements throughout the specification.

Hereinafter, an exemplary embodiment of the invention will be described in detail with reference to the accompanying drawings. Further, a name of a constituent elements used in description below may be selected in consideration of easiness of writing the specification, and thus may be different from a name of a component of an actual product.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

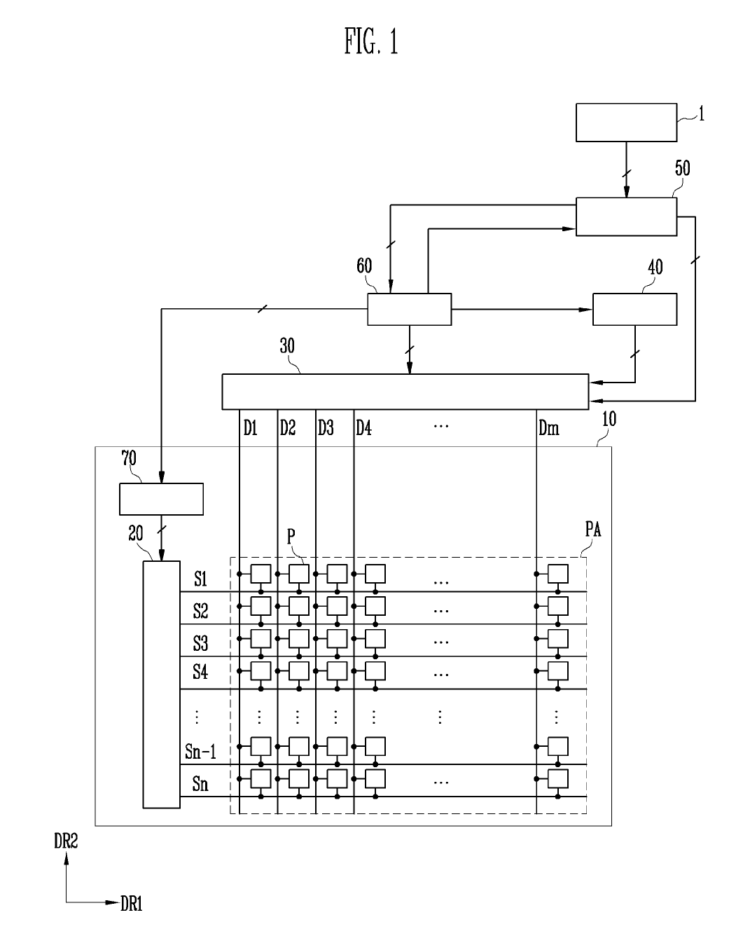

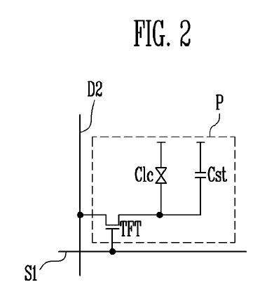

FIG. 1 is a block diagram illustrating a display device according to an exemplary embodiment of the invention, and FIG. 2 is a top plan view illustrating one pixel of FIG. 1.

The display device according to the exemplary embodiment of the invention may be implemented by a display device, such as a liquid crystal display (“LCD”), a field emission display, a plasma display panel, and an organic light emitting display device. The invention will be described based on that the display device is implemented by an LCD, but the invention is not limited thereto.

Referring to FIGS. 1 and 2, the display device according to the exemplary embodiment of the invention may include a display panel 10, a shift register 20, a data driver 30, a gamma voltage supplying unit 40, a timing controller 50, a power supply unit 60, a scan driver 70, and the like.

The display panel 10 includes an upper substrate, a lower substrate, and a liquid crystal layer disposed therebetween. A pixel array PA is disposed on the lower substrate of the display panel 10. The pixel array PA displays an image in areas provided by a crossing structure of data lines D1 to Dm (m is a positive integer equal to or larger than 2) and scan lines S1 to Sn (n is a positive integer equal to or larger than 2) using pixels P arranged in a matrix form. In an exemplary embodiment, the scan lines S1 to Sn extend in the first direction DR1, and the data lines D1 to Dm extends in a second direction DR2 and.

In the exemplary embodiment of the invention, the pixel P is connected to a corresponding scan line S1 among the scan lines S1 to Sn, and a corresponding data line D2 among the data lines D1 to Dm. The pixel P includes a thin film transistor TFT, a liquid crystal capacitor Clc, a storage capacitor Cst, and a pixel electrode. Referring to FIG. 2, a gate electrode of the thin film transistor TFT is connected to the scan line S1, a source electrode of the thin film transistor TFT is connected to the data line D2, and a drain electrode of the thin film transistor TFT is connected to the liquid crystal capacitor Clc and the storage capacitor Cst connected to a common voltage, for example.

The thin film transistor TFT is turned on by a scan signal of the scan line S1 to supply a data voltage of the data line D2 to a pixel electrode of the pixel P. The storage capacitor Cst maintains a data voltage supplied to the pixel electrode for a predetermined period of time. The pixel P expresses a gray by driving a liquid crystal of the liquid crystal layer by an electric field generated between the pixel electrode, to which the data voltage is supplied, and a common electrode, to which the common voltage is applied, and adjusting the quantity of light transmitted.

A black matrix and color filters may be disposed on the upper substrate of the display panel 10, but are not limited thereto. The black matrix and the color filters may be disposed on the lower substrate of the display panel 10. In an exemplary embodiment, the common electrode is disposed on the upper substrate in a case of a vertical electric field driving scheme, such as a twisted nematic (“TN”) mode and a vertical alignment (“VA”) mode, and is disposed on the lower substrate together with the pixel electrode in a case of a horizontal electric field driving scheme, such as an in-plane switching (“IPS”) mode and a fringe field switching (“FFS”) mode. The display panel 10 according to the exemplary embodiment of the invention may be implemented in any liquid crystal mode, as well as the TN mode, the VA mode, the IPS mode, and the FFS mode.

A polarizing plate is attached onto an external surface of each of the upper substrate and the lower substrate of the display panel 10, and an alignment layer for setting a pre-tile angle of the liquid crystal is disposed on an internal surface of each of the upper substrate and the lower substrate of the display panel 10.

A backlight unit (not illustrated) for uniformly irradiating light to the display panel 10 may be disposed under the display panel 10. In an exemplary embodiment, the backlight unit may be implemented in a direct type or an edge type, for example. However, the invention is not limited thereto, and the backlight unit may include various other types.

The gamma voltage supplying unit 40 receives at least one power voltage from the power supply unit 60. The gamma voltage supply unit 40 divides the power voltage and a predetermined voltage using a voltage dividing circuit and generates a plurality of gamma reference voltages. In an exemplary embodiment, the predetermined voltage may be the common voltage or a ground voltage, for example. The gamma voltage supply unit 40 outputs the plurality of gamma reference voltages to the data driver 30.

The data driver 30 includes at least one source drive integrated circuit (“IC”).

The source drive IC receives digital video data and a data timing control signal from the timing controller 50. The source drive IC receives the plurality of gamma reference voltages from the gamma voltage supplying unit 40.

The source drive IC may divide the plurality of gamma reference voltages using the voltage dividing circuit and generate gamma compensation voltages. In this case, the source drive IC may select any one of the gamma compensation voltages according to the digital video data, and output the selected gamma compensation voltage as a data voltage. Particularly, the source drive IC synchronizes each of the scan signals in response to the data timing control signal of the timing controller 50 and outputs the data voltage to the data lines D1 to Dm of the display panel 10. As a result, the data voltage is supplied to each of the pixels P selected by the scan signal.

In an exemplary embodiment, the source drive IC may be disposed (e.g., embedded) in a flexible circuit board, such as a chip on film (“COF”) and a tape carrier package (“TCP”), for example.

In an exemplary embodiment, the timing controller 50 receives the digital video data from a host system 1 through an interface, such as a low voltage differential signaling (“LVDS”) interface and a transition minimized differential signaling (“TMDS”) interface, for example. However, the invention is not limited thereto, and timing controller 50 may receive the digital video data through various other interfaces. In an exemplary embodiment, the timing controller 50 receives timing signals including a vertical sync signal, a horizontal sync signal, a data enable signal, a dot clock signal, and the like from the host system 1, for example.

In an exemplary embodiment, the host system 1 may be implemented by any electronic devices such as a television system, a set-top box, a navigation system, a DVD player, a blueray player, a personal computer (“PC”), a home theater system, and a phone system, for example. The host system 1 converts digital video data of an input image into a format appropriate to the display panel 10.

The timing controller 50 generates a data timing control signal for controlling an operation timing of the data driver 30 and a scan timing control signal for controlling an operation timing of the shift register 20 in response to the timing signals. The timing controller 50 outputs the scan timing control signal to the scan driver 70. The timing controller 50 outputs the digital video data and the data timing control signal to the data driver 30.

In an exemplary embodiment, the power supply unit 60 receives a predetermined voltage from an internal power supply source such as a battery included in the display device or an external power supply source. The power supply unit 60 supplies driving voltages and direct-current (“DC”) voltages to the shift register 20, the data driver 30, the scan driver, and the timing controller 50 using a predetermined voltage. Particularly, the power supplying unit 60 supplies a data driving voltage, that is a digital driving voltage of the data driving unit 30, to the data driver 30, and supplies a timing driving voltage, that is a digital driving voltage of the timing controller 50, to the timing controller 50. Further, the power supply unit 60 supplies a common voltage to common lines of the display panel 10.

The scan driver 70 receives a scan timing control signal and a power voltage supply control signal from the timing controller 50, and receives a DC voltage from the power supply unit 60. In an exemplary embodiment, the scan timing control signal may include a scan start pulse and clock signals, for example.

The scan driver 70 includes a level shifter, which converts a voltage level of the scan timing control signal into a swing width appropriated to the driving of the thin film transistor TFT of the pixel P. In an exemplary embodiment, the level shifter level-shifts a transistor-transistor-logic (“TTL”) logic level voltage of the scan timing control signal to a gate high voltage and a gate low voltage, for example.

In an exemplary embodiment, the TTL logic level voltage may be, for example, a voltage swing between approximately 0 volt (V) and approximately 3.3 V. The gate high voltage and the gate low voltage may be set as operation voltages of the shift register 20 and the thin film transistor TFT of the display panel 10. In an exemplary embodiment, the gate high voltage may be set to a voltage equal to or larger than approximately 15 V, and the gate low voltage may be set to a voltage equal to or lower than approximately 0 V, for example.

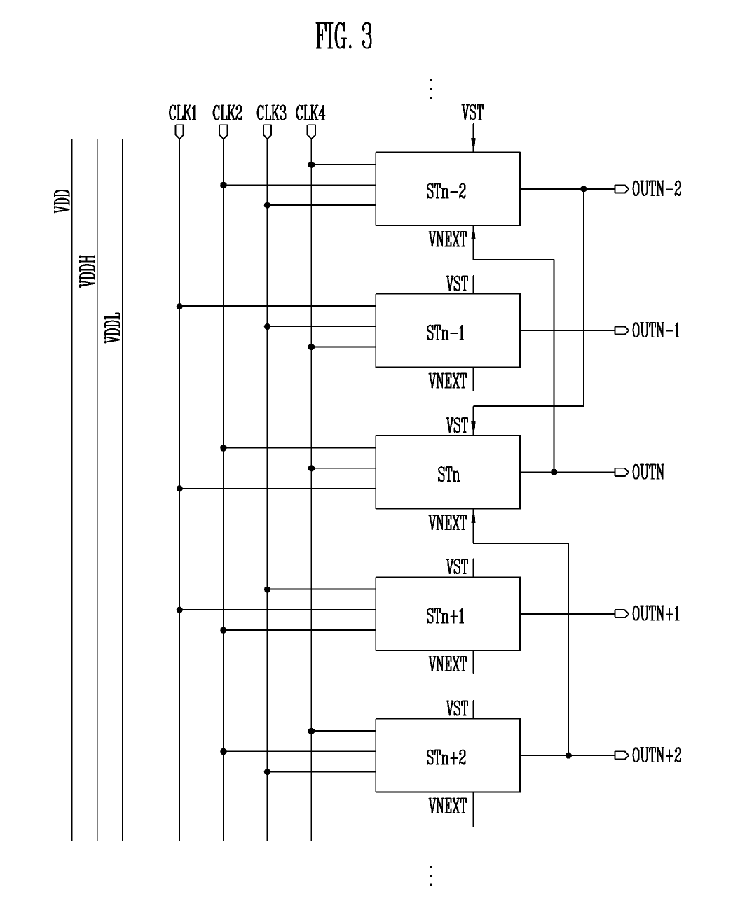

The shift register 20 is directly disposed on the lower substrate of the display panel 10 together with the pixel array PA at one side of the display panel 10 in the gate drive IC in panel (“GIP”) method. Hereinafter, the shift register 20 will be described with reference to FIG. 3.

FIG. 3 is a circuit diagram illustrating the shift register of FIG. 1.

Referring to FIGS. 1 and 3, the shift register 20 includes a plurality of stages STn−2 to STn+2, which are subordinately connected. The shift register 20 sequentially supplies scan signals OUTN−2 to OUTN+2 to the scan lines S1 to Sn based on the level-shifted signals provided from the scan driver 70. Each of the plurality of stages STn−2 to STn+2 may include a plurality of transistors (not illustrated), which are provided by the same process as that of the thin film transistor TFT disposed in the pixel array PA of FIG. 1.

In an exemplary embodiment, the level-shifted signals include signals VST, CLK1 to CLK4, VDD, VDDH, and VDDL swing between the gate high voltage and the gate low voltage, for example. The VDD is a high potential voltage, and may be set to the gate high voltage. The VDDH and the VDDL may be set to a voltage for compensating for stress of the stages STn−2 to STn+2 of the shift register 20 or the gate low voltage.

A start pulse VST, or an output of the n−2^{th} stage STn−2 as a start pulse VST is input into a start terminal of the n^{th} stage STn. An output VNEXT of the n+2^{th} stage STn+2 is input into a reset terminal of the n^{th} stage STn. An output terminal of the nth stage STn is connected to the corresponding scan line among the scan lines S1 to Sn.

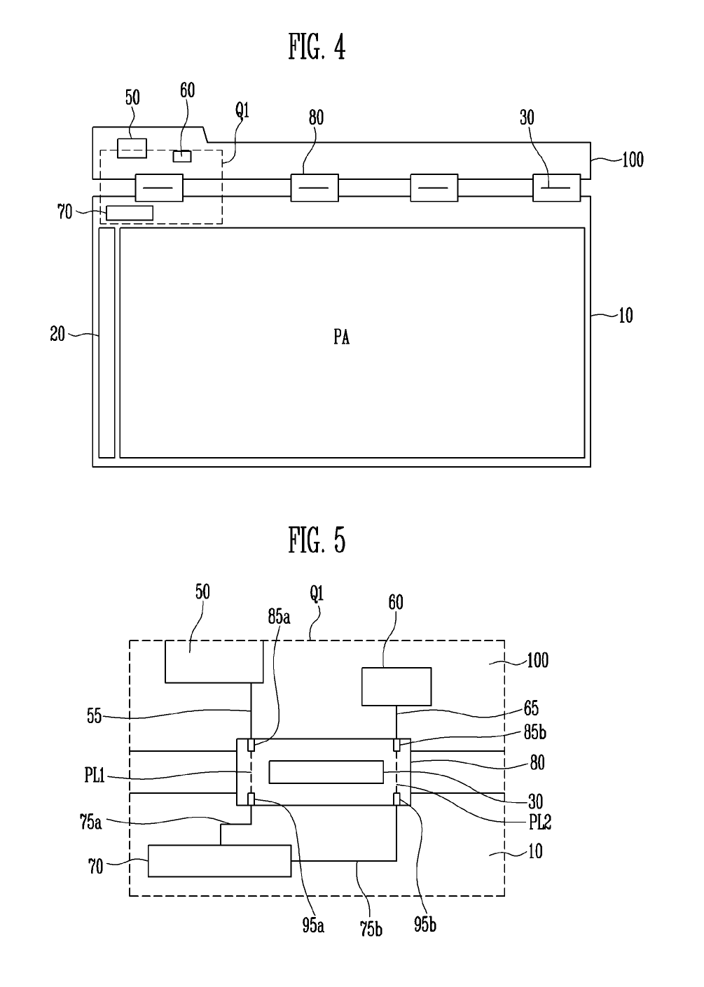

Hereinafter, the scan driver, the flexible circuit board, and a connection relation between the scan driver and the flexible circuit board in the display device according to the exemplary embodiment of the invention will be described with reference to FIGS. 4 and 5.

FIG. 4 is a top plan view for describing a connection relation between the printed circuit board (“PCB”) and the display panel, and FIG. 5 is an enlarged top plan view of a part Q1 of FIG. 4.

Referring to FIGS. 4 and 5, the display device according to the exemplary embodiment of the invention includes the display panel 10, the shift register 20, the data driver 30, the scan driver 70, and the PCB 100. Further, the display device according to the exemplary embodiment of the invention further includes the timing controller 50 and the power supply unit 60 disposed (e.g., embedded) in the PCB 100.

The display panel 10 includes the upper substrate, the lower substrate, and the liquid crystal layer disposed therebetween. The pixel array PA is disposed on the lower substrate of the display panel 10. Further, a first line-on-glass (“LOG”) wire 75a and a second LOG wire 75b, which are electrically connected with the scan driver 70, are disposed on the lower substrate of the display panel 10.

The shift register 20 is disposed in a peripheral area of the pixel array PA at one side of the display panel 10. The shift register 20 is directly disposed (e.g., embedded) in a substrate of the display panel 10 together with the pixel array PA.

In an exemplary embodiment, the data driving unit 30 may include the source drive IC, and the source drive IC may be disposed (e.g., embedded) in the flexible circuit board 80, such as a COF and a TCP. Hereinafter, the flexible circuit board 80 will be described based on a COF, but is not limited thereto.

In an exemplary embodiment, one side of the flexible circuit board 80 is bonded to the PCB 100 through an anisotropic conductive film (“ACF”), and the other side thereof is bonded to one side of the display panel 10 through the ACF, for example. However, the invention is not limited thereto, and the flexible circuit board 80 may be bonded to the PCB 100 through various other films.

The flexible circuit board 80 includes a plurality of input terminals and a plurality of output terminals. For convenience of the description, only a first input terminal 85a and a second input terminal 85b among the plurality of input terminals are illustrated in the drawing. Further, only a first output terminal 95a and a second output terminal 95b among the plurality of output terminals are illustrated in the drawing.

Here, the first input terminal 85a is electrically connected with the timing controller 50, and the second input terminal 85b is electrically connected with the power supply unit 60. The first input terminal 85a is electrically connected with the first output terminal 95a through a first pad line PL1, and the second input terminal 85b is electrically connected with the second output terminal 95b through a second pad line PL2. The first output terminal 95a is electrically connected with the scan driver 70 through the first LOG wire 75a, and the second output terminal 95b is electrically connected with the scan driver 70 through the second LOG wire 75b.

The scan driver 70 is disposed in a peripheral area surrounding the pixel array PA so as not to overlap the shift register 20 at one side of the display panel 10. In an exemplary embodiment, the scan driver 70 may include the scan drive IC disposed (e.g., embedded) in the chip on glass (“COG”) method at one side of the display panel 10, for example.

The scan drive IC may include the level shifter, which converts the scan timing control signal provided from the timing controller 50 into a swing width appropriate to the driving of the display panel 10.

A first conductive wire 55 electrically connected with the first input terminal 85a of the flexible circuit board 80 and a second conductive wire 65 electrically connected with the second input terminal 85b of the flexible circuit board 80 are disposed on the PCB 100.

One side of the first conductive wire 55 is connected to the timing controller 50, and the other side thereof is connected to the first input terminal 85a. One side of the second conductive wire 65 is connected to the power supply unit 60, and the other side thereof is connected to the second input terminal 85b.

The timing controller 50 is disposed (e.g., embedded) in the PCB 100, and generates a data timing control signal for controlling an operation timing of the data driver 30 and a scan timing control signal for controlling an operation timing of the shift register 20. The control signals output from the timing controller 50 are finally provided to the scan driver 70 via the first conductive wire 55, the flexible circuit board 80, and the first LOG wire 75a.

The power supply unit 60 is disposed (e.g., embedded) in the PCB 100 and outputs DC power, such as the common voltage, the gate high voltage, the gate low voltage, and the gamma reference voltage for driving the display panel 10. The DC power output from the power supply unit 60 is finally provided to the scan driver 70 via the second conductive wire 65, the flexible circuit board 80, and the second LOG wire 75b.

The scan driver 70 level-shifts a voltage level of the control signal provided from the timing controller 50 to a swing width appropriate to the driving of the display panel 10 using the DC power provided from the power supply unit 60.

The signals level-shifted by the scan driver 70 are directly provided to the shift register 20 on the substrate of the display panel 10, so that signal distortion may be decreased compared to a case where the signal is transmitted through the PCB 100, the flexible circuit board 80, the display panel 10, and the like.

Further, the level-shifted signals are directly provided to the shift register 20 from the scan driver 70 disposed on the substrate of the display panel 10, so that the number of LOG wires within the display panel 10 may be decreased compared to a case where the shift register 20 receives the level-shifted signals through the PCB. Accordingly, it is possible to implement a narrow bezel of the display panel 10.

As described above, the scan driver 70 is disposed (e.g., embedded) at one side of the display panel 10 together with the shift register 20, so that the timing controller 50, the power supply unit 60, and the like are disposed (e.g., embedded) in the PCB 100. Only the timing controller 50 and the power supply unit 60 are disposed (e.g., embedded) in the PCB 100, so that the number of components disposed (e.g., embedded) in the PCB 100 may be decreased, and thus a size of the PCB 100 may be decreased. When a size of the PCB 100 is decreased, manufacturing cost of the PCB 100 may be decreased.

Further, only the timing controller 50 and the power supply unit 60 are disposed (e.g., embedded) in the PCB 100, the PCB 100 may be applicable to all of the display panels 10, of which structures are changed according to a specification of a product. As one example, the PCB 100 is applicable to both a case where the scan drive IC is disposed (e.g., embedded) at one side of the display panel by the COG method and a case where the scan drive IC is disposed (e.g., embedded) at one side of the display panel 10 together with the pixel array PA of FIG. 1 by the GIP method.

It will be appreciated by those skilled in the art that the invention as described above may be implemented into other specific forms without departing from the technical spirit thereof or essential characteristics. Therefore, the aforementioned embodiments are all illustrative and are not restricted to a limited form. The scope of the invention is represented by the claims to be described below rather than the detailed description, and it is to be interpreted that the meaning and scope of the claims and all the changes or modified forms derived from the equivalents thereof come within the scope of the invention.

What is claimed is:

1. 1 A display device, comprising:
a display panel including a pixel array, in which pixels connected to a plurality of data lines and a plurality of scan lines are disposed in a matrix form;
a timing controller which controls driving of the display panel;
a power supply unit which supplies power for driving the display panel;
a printed circuit board in which the timing controller and the power supply unit are disposed;
a flexible circuit board, which includes one end connected to the display panel and the other end connected to the printed circuit board and electrically connects the display panel and the printed circuit board;
a data driving unit which is disposed in the flexible circuit board and which provides a data signal to the plurality of data lines;
a shift register which is directly disposed on a substrate of the display panel and which sequentially provides a scan signal to the plurality of scan lines; and
a scan driver which is disposed at one side of the display panel, and which provides level-shifted signals using a clock signal provided from the timing controller and power provided from the power supply unit to the shift register.

2. The display device of claim 1, wherein the scan driver includes a level shifter disposed in the substrate of the display panel.

3. The display device of claim 1, wherein the shift register is disposed in a peripheral area of the pixel array.

4. The display device of claim 1, wherein the scan driver is disposed on the substrate of the display panel and spaced apart from the shift register.

5. The display device of claim 1, wherein the printed circuit board includes a first conductive wire, which electrically connects the flexible circuit board and the timing controller, and a second conductive wire, which electrically connects the flexible circuit board and the power supply unit.

6. The display device of claim 1, wherein the shift register includes a plurality of transistors disposed on the substrate of the display panel together with the pixel array 7 The display device of claim 1, wherein the flexible circuit board includes a chip on film.

8. The display device of claim 1, further comprising:
a connection wire which is positioned at one side of the display panel and which electrically connects the flexible circuit board and the scan driver.

9. The display device of claim 8, wherein the connection wire includes line-on-glass wires directly disposed on the substrate of the display panel.

10. The display device of claim 1, wherein the data driving unit includes at least one source drive integrated circuit.

11. The display device of claim 10, wherein the source drive integrated circuit is disposed in the flexible circuit board.

12. The display device of claim 1, wherein the flexible circuit board is one of a chip on film and a tape carrier package.

13. The display device of claim 1, wherein the flexible circuit board is bonded to the printed circuit board through an anisotropic conductive film.
